(19) United States
(12) Patent Application Publication
(10) Pub. No.: US 2010/0013368 A1
(43) Pub. Date: Jan. 21, 2010

(54) BULB-TYPE FLUORESCENT LAMP

(75) Inventors: Takahiro Konomoto, Yokohama (JP); Hironori Nishio, Yokohama (JP); Takashi Osawa, Yokohama (JP)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/528,639

(22) PCT Filed: Feb. 25, 2008
(86) PCT No.: PCT/JP2008/053188

§ 371 Date: Aug. 26, 2009

(30) Foreign Application Priority Data
Feb. 26, 2007 (JP) 2007-045178
Feb. 26, 2007 (JP) 2007-045179

(51) Int. Cl. H01J 61/52

(52) U.S. Cl. 313/46

(57) ABSTRACT

A bulb-type fluorescent lamp using a helical luminous tube is provided. The bulb-type fluorescent lamp includes a plate to which an electrode-side end portion of the helical luminous tube is fixed; a housing having an end to which a base is joined and another end to which the plate is fixed in an opening side; an outer tube globe which is inserted and fixed in a gap between the housing and the plate in the opening side of the housing and houses the helical luminous tube; a projecting portion which is provided in an end portion of the helical luminous tube in the side opposite to electrodes and serves as a coldest-point part; a thermally conductive medium which thermally couples the projecting portion with the outer tube globe; and a retention portion which is provided in the projecting portion and, when the outer tube globe is broken along the plate circumferentially with respect to the opening, retains the outer tube globe, which is broken along the plate circumferentially with respect to the opening, via the thermally conductive medium.

### FIELD OF THE INVENTION

The present invention relates to a bulb-type fluorescent lamp using a helical luminous tube and, particularly, relates to the bulb-type fluorescent lamp capable of preventing fall of an outer tube globe when the outer tube globe is broken along a plate circumferentially with respect to opening. The present invention also relates to the bulb-type fluorescent lamp using the helical luminous tube in which pure mercury is sealed.

### BACKGROUND OF THE INVENTION

Recently, bulb-type fluorescent lamps are downsized to the degree equivalent to general incandescent bulbs, and the demand for replacing light sources of the equipment for general incandescent bulbs by bulb-type fluorescent lamps has been promoted.

As an example of the bulb-type fluorescent lamp, a fluorescent lamp which is downsized by elongating a discharge path by bending a luminous tube helically has been proposed (for example, see Patent Document 1).

In order to provide a bulb-type fluorescent lamp which can suppress temperature increase of the luminous tube even when the luminous tube emits light and does not largely deteriorate the design property of the lamp, the bulb-type fluorescent lamp has the luminous tube having a double-helical shape, a holder supporting the luminous tube, a case attaching the holder and having a base, and a globe covering the luminous tube. The globe is the A type (electronic A shape), and a diffusion film for diffusing the light emitted from the luminous tube is formed on the inner surface thereof. Moreover, the luminous tube has a projecting portion which serves as a coldest-point part of the luminous tube when the lamp is lighted. In a proposed low-pressure mercury lamp, the projecting portion is on the circling axis of the double-helical shape, which is the shape of the luminous tube, and thermally joined with the globe via a thermal conduction medium (for example, see Patent Document 2).

FIG. 8 and FIG. 9 are drawings showing a conventional bulb-type fluorescent lamp 1; wherein FIG. 8 is a front view showing a cross section of the bulb-type fluorescent lamp 1, and FIG. 9 is a front view of a helical luminous tube 2. As shown in FIG. 8, the bulb-type fluorescent lamp 1 has a housing 4 made of resin having an end to which a base 5 having an electric connection portion is joined and an outer tube globe 6 made of glass which houses a helical luminous tube 2 shown in FIG. 9 in the interior thereof and is joined with the other end of the housing 4.

An end portion of the helical luminous tube 2 is inserted in the plate 8 and affixed to the plate 8 by an adhesive agent such as silicon. A ballast 3 (lighting circuit) which is mounted on a substrate 9 and composed of various electronic parts is attached to the opposite side of the plate 8 with respect to the helical luminous tube 2.

The plate 8, which the helical luminous tube 2 and the ballast 3 are attached to, is fixed to the housing 4. Furthermore, the outer tube globe 6 is mounted in the gap between the housing 4 and the plate 8 by a adhesive.

At the distal end (in the side opposing to the plate 8) of the helical luminous tube 2, a projecting portion 2a, which serves as the coldest-point part of the helical luminous tube 2 is formed. The projecting portion 2a is thermally joined with the outer tube globe 6 via a silicon resin 10 which is a thermally conductive resin. The shape of the projecting portion 2a is semispherical at the distal end, and the part therefrom to the root portion has a cylindrical shape.

Patent Document 1: Japanese Patent Application Laid-Open (kokai) No. 2003-263972
Patent Document 2: Japanese Patent Application Laid-Open (kokai) No. 2004-311032

### DISCLOSURE OF THE INVENTION

### Problem to be Solved by the Invention

The conventional bulb-type fluorescent lamp 1 using the helical luminous tube 2 is configured in the above described manner and thus implicates the following problems.

(1) The outer tube globe 6 is made of glass. However, when the glass is inferior, cracks may appear, and it might brake. In this case, in the conventional bulb-type fluorescent lamp 1, since the projecting portion 2a of the helical luminous tube 2 is affixed to the outer tube globe 6 via the silicon resin 10, the outer tube globe 6 is tentatively retained by the helical luminous tube 2. However, the shape of the projecting portion 2a is semispherical at the distal end, and the part therefrom to the root portion has a cylindrical shape. Therefore, when a downward load of the silicon resin 10 (weight of the outer tube globe 6 broken along the plate circumferentially with respect to the opening) is applied, the projecting portion 2a does not have apart that catches the silicon resin 10. Therefore, when the outer tube globe 6 is broken, it might fall.
(2) The projecting portion 2a of the helical luminous tube 2 is thermally affixed to the outer tube globe 6 via the silicon resin 10; therefore, the heat generated from the helical luminous tube 2 is transmitted from the silicon resin 10 to the outer tube globe 6 and dissipated. As a result, the temperature of the projecting portion 2a which serves as the coldest-point part of the helical luminous tube 2 is lowered, and the mercury vapor pressure in the helical luminous tube 2 approaches an optimum value. However, the surface area of the projecting portion 2a is not large enough.

Moreover, since the rise of a light flux is slow in the conventional bulb-type fluorescent lamp using an amalgam, there is a tendency that a bulb-type fluorescent lamp of a non-amalgam type in which pure mercury is sealed in a luminous tube, is used. In the bulb-type fluorescent lamp of the non-amalgam type in which pure mercury is sealed in the luminous tube, the temperature of the projecting portion which serves as the coldest-point part of the luminous tube is important. Particularly, in the lamp that is equipped with an outer tube globe, the temperature of the projecting portion becomes high. Therefore, reducing the temperature of the projecting portion is important to ensure light flux upon lighting.

The present invention has been accomplished to solve the above described problems, and it is an object of the present invention to provide a bulb-type fluorescent lamp which has a small possibility of falling of the outer tube globe made of glass even when it is broken and is capable of reducing the thermal resistance between the projecting portion serving as a coldest-point part of a helical luminous tube and a silicon resin.

Moreover, the present invention has been accomplished in order to solve the above described problems and it is an object of the present invention to provide a bulb-type fluorescent lamp capable of properly controlling the temperature of the projecting portion serving as the coldest-point part of the luminous tube.

### Means for Solving Problem

A bulb-type fluorescent lamp according to the present invention is a bulb-type fluorescent lamp using a helical luminous tube, characterized by having: a plate to which an electrode-side end portion of the helical luminous tube is fixed; a housing having an end to which a base is joined and the other end to which the plate is fixed in an opening side; an outer tube globe which is inserted and fixed in a gap between the housing and the plate in the opening side of the housing and houses the helical luminous tube; a projecting portion which is provided in an end portion of the helical luminous tube in the side opposite to electrodes and serves as a coldest-point part; a thermally conductive medium which thermally couples the projecting portion with the outer tube globe; and a retention portion which is provided in the projecting portion and, when the outer tube globe is broken along the plate circumferentially with respect to the opening, retains the outer tube globe, which is broken along the plate circumferentially with respect to the opening, via the thermally conductive medium.

Moreover, the bulb-type fluorescent lamp according to the present invention is characterized in that the retention portion is embedded in the thermally conductive medium.

Moreover, the bulb-type fluorescent lamp according to the present invention is characterized in that the retention portion provided in the projecting portion of the helical luminous tube is composed of a large-diameter portion with a larger diameter than the other part of the projecting portion.

Moreover, the bulb-type fluorescent lamp according to the present invention is characterized in that a cross section of the large-diameter portion has an inverted T shape.

Moreover, the bulb-type fluorescent lamp according to the present invention is characterized in that the cross section of the large-diameter portion has an L shape.

Moreover, the bulb-type fluorescent lamp according to the present invention is characterized in that the cross section of the large-diameter portion has an anchor shape.

Moreover, the bulb-type fluorescent lamp according to the present invention is characterized in that the projecting portion of the helical luminous tube has a shape in which a middle part is narrowed in order to form the retention portion.

Furthermore, a bulb-type fluorescent lamp according to the present invention is a bulb-type fluorescent lamp using a helical luminous tube in which pure mercury is sealed having: a plate to which an electrode-side end portion of the helical luminous tube is fixed; a housing having an end to which a base is joined and the other end in an opening side to which the plate is fixed; an outer tube globe which is inserted and affixed in the gap between the housing and the plate in the opening side of the housing and houses the helical luminous tube; a projecting portion which is located in an end portion of the helical luminous tube, opposite to the electrodes and serves as a coldest-point part; and a thermally conductive medium which thermally couples the projecting portion with the outer tube globe; wherein, when the tube diameter of the helical luminous tube is d₀, and the tube diameter of the projecting portion is d₁,

d₁/d₀≧0.75 (1).

Moreover, the bulb-type fluorescent lamp according to the present invention is characterized in that a silicon resin is used as the thermally conductive medium.

### EFFECT OF THE INVENTION

In the bulb-type fluorescent lamp according to the present invention, the retention portion, which retains the broken outer tube globe via the thermally conductive medium when the outer tube globe is broken is provided in the projecting portion of the helical luminous tube; therefore, the possibility of falling is small even when the outer tube globe made of glass is broken.

Moreover, in the bulb-type fluorescent lamp according to the present invention, the retention portion which is provided in the projecting portion of the helical luminous tube is composed of the large-diameter portion. As a result, in addition to the above described effect, the thermal resistance between the projecting portion serving as the coldest-point part of the helical luminous tube and the silicon resin can be reduced. Therefore, the temperature of the projecting portion serving as the coldest-point part can be reduced.

Furthermore, in the bulb-type fluorescent lamp according to the present invention, when the expression d₁/d₀≧0.75 is met, the coldest-point temperature can be reduced further than that of conventional bulb-type fluorescent lamps, and the total light flux can be improved.

### BRIEF DESCRIPTION OF THE DRAWINGS

FIG. 1 is a drawing showing a first embodiment and is a front view of a bulb-type fluorescent lamp 1;

FIG. 2 is a drawing showing the first embodiment and is an A-A cross sectional view of FIG. 1;

FIG. 3 is a drawing showing the first embodiment and is a front view showing a cross section of the bulb-type fluorescent lamp 1;

FIG. 4 is a drawing showing a second embodiment and is a front view of a bulb-type fluorescent lamp 101;

FIG. 5 is a drawing showing the second embodiment and is an A-A cross sectional view of FIG. 4;

FIGS. 6A and 6B are drawings showing the second embodiment and a front view and a plan view of a helical luminous tube 102;

FIG. 7 is a diagram showing the second embodiment and is a diagram showing the relation between the tube diameter d₁ of a projecting portion 102a/the tube diameter d₀ of the helical luminous tube and the temperature of the projecting portion 102a (coldest point);

FIG. 8 is a front view showing a cross section of a conventional bulb-type fluorescent lamp 1; and

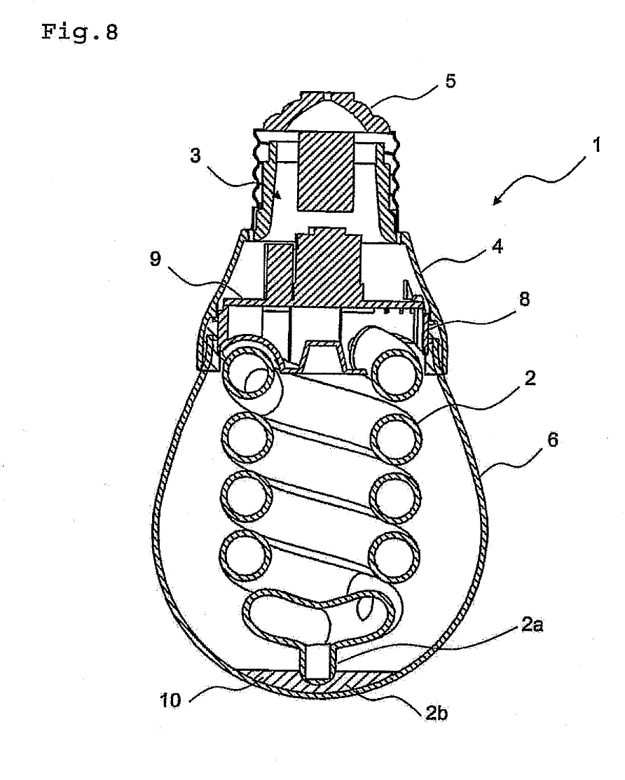

FIG. 9 is a front view of a helical luminous tube 2 of the conventional bulb-type fluorescent lamp 1.

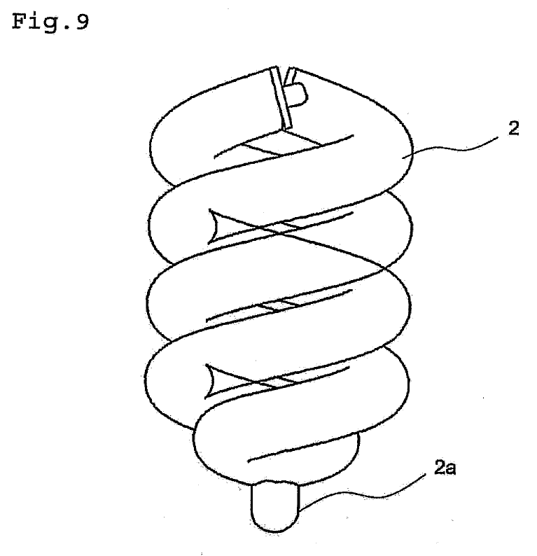

### DESCRIPTION OF REFERENCE NUMERALS

1, 101: bulb-type fluorescent lamp; 2, 102: helical luminous tube; 2a, 102a: projecting portion; 2b: large-diameter portion; 3, 103: ballast; 4, 104: housing; 5, 105: base; 6, 106: outer tube globe; 8, 108: plate; 9, 109: substrate; and 10, 110: silicon resin.

### DESCRIPTION OF THE PREFERRED EMBODIMENTS

### First Embodiment

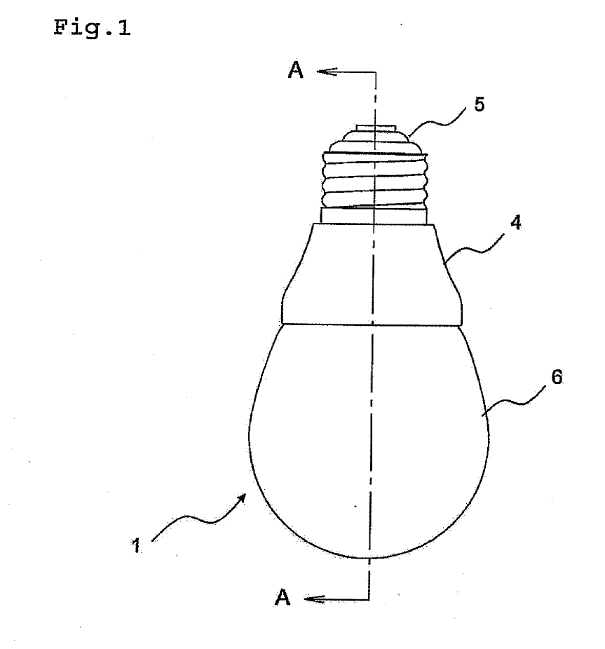

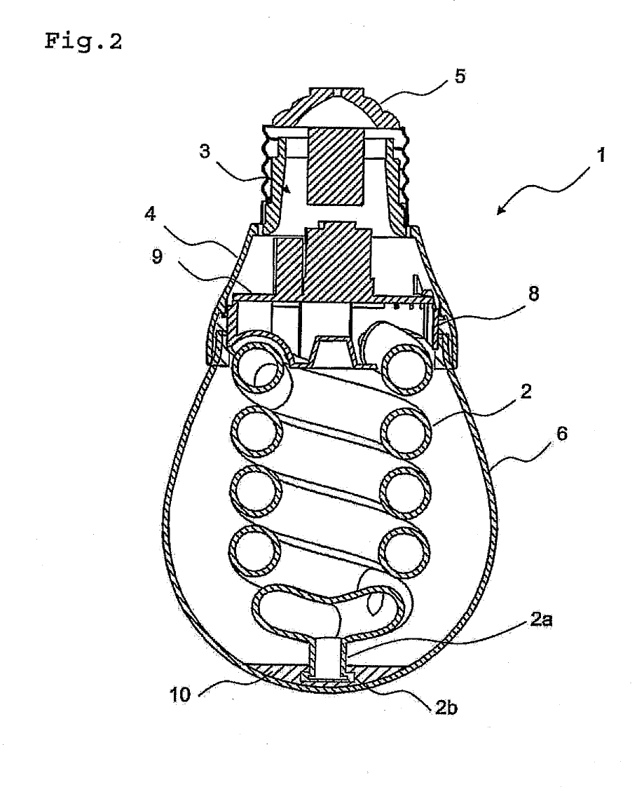

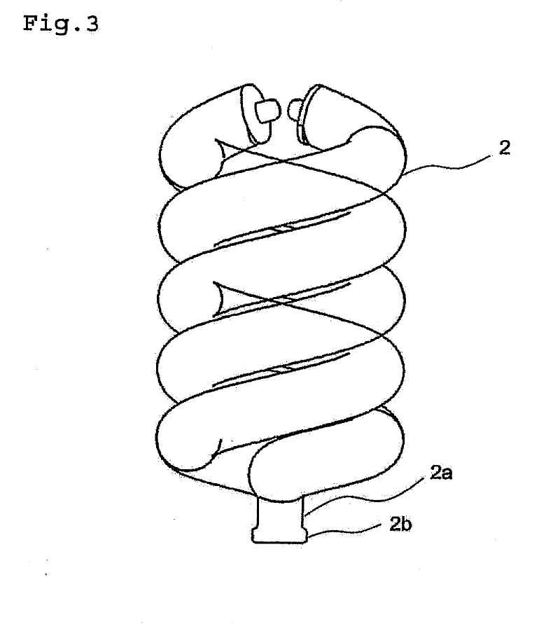

FIG. 1 to FIG. 3 are drawings showing a first embodiment; wherein FIG. 1 is a front view of a bulb-type fluorescent lamp 1, FIG. 2 is an A-A cross sectional view of FIG. 1, and FIG. 3 is a front view of a helical luminous tube 2.

First of all, the appearance of the bulb-type fluorescent lamp 1 will be described with reference to FIG. 1. The bulb-type fluorescent lamp 1 is an example of the A type of general bulb types. The bulb-type fluorescent lamp 1 has a housing 4 made of a resin having an end to which a base 5 (E26) having an electric joint portion with an unshown socket is affixed to and an outer tube globe 6 made of glass which houses the helical luminous tube 2 in the interior thereof and joined with the other end of the housing 4. On the inner surface of the outer tube globe 6, a diffusion film (not shown) for diffusing the light that is emitted from the helical luminous tube 2 is formed so that the interior of the outer tube globe 6 cannot be seen.

The configuration of the interior of the bulb-type fluorescent lamp 1 will be described with reference to FIG. 2. In the bulb-type fluorescent lamp 1, an electrode-side end portion of the helical luminous tube 2 (double-helical shape as shown in FIG. 3) is inserted into a plate 8 and affixed to the plate 8 by an adhesive agent such as silicon. The explanation of the electrode-side end portion will be omitted since it is not a main subject in the present embodiment. In the helical luminous tube 2, a predetermined amount of mercury is sealed in the form of an elementary substance. Moreover, as a buffer gas, a mixed gas of argon/neon gases is sealed from an exhaust tube (not shown).

A substrate 9 is attached to the surface of the plate 8 in the side opposite to the helical luminous tube 2 (base side). Various electronic parts are mounted on the substrate 9. These various electronic parts constitute a ballast 3 (lighting circuit) which lights the helical luminous tube 2.

The plate 8 to which the helical luminous tube 2 and the substrate 9 are attached to is fitted and affixed to the inside of the housing 4 by adhesion, and the like. In the opening side (opposite to the base 5 of the housing 4, a gap is generated between the housing 4 and the plate 8. The opening-side end portion of the outer tube globe 6 is inserted in the gap, and the outer tube globe 6 is fixed to the housing 4 and the plate 8, for example, by an adhesive agent such as a silicon resin.

Characteristics of the present embodiment take the form of the projecting portion 2a and the helical luminous tube 2. The distal end of the projecting portion 2a is arranged to have a larger diameter than the other part. This part is a large-diameter portion 2b (example of a retention portion).

The projecting portion 2a of the helical luminous tube 2 is thermally joined with the outer tube globe 6 via the silicon resin 10 having thermal conductivity (example of a thermally conductive medium). The silicon resin 10 is filled in so that the large-diameter portion 2b is embedded in the silicon resin 10. The large-diameter portion 2b may be any part of the projecting portion 2a. At the distal end, the amount of the silicon resin 10 is small.

When the large-diameter portion 2b, in which the distal end has a larger diameter than the other part, is provided in the projecting portion 2a of the helical luminous tube 2, and the large-diameter portion 2b is configured to be embedded in the silicon resin 10 in the above described manner, even if the outer tube globe 6 made of glass is broken in any way, the silicon resin 10 is held in place by the large-diameter portion 2b, and the possibility that the outer tube globe 6 might fall is reduced.

The opening side of the outer tube globe 6 is cut, and the vicinity of the cut opening is subjected to heating and annealing in order to perform a distortion removing treatment. However, circumferential distortion tends to remain along side the opening and, when the heating and annealing is insufficient, the thermal stress, such as heat generation and cooling upon light-off of the lamp, causes a crack circumferentially along the opening in some cases.

Moreover, when the large-diameter portion 2b is provided in the projecting portion 2a of the helical luminous tube 2, the surface area of the projecting portion 2a is increased. As a result, the thermal resistance between the projecting portion 2a and the silicon resin 10 is reduced, and the effect of reducing the temperature of the projecting portion 2a, which is the coldest-point part, is obtained.

The shape of the large-diameter portion 2b of the projecting portion 2a of the helical luminous tube 2 includes various shapes other than the shape shown in FIG. 2 and FIG. 3 which has the inverted T shape in the cross section. Any shape can be employed, as long as the silicon resin 10 is held by the large-diameter portion 2b of the projecting portion 2a of the helical luminous tube 2, and falling of the outer tube globe 6 is prevented by the shape, even when the outer tube globe 6 is broken. For example, the cross section can be J-shaped, L-shaped, anchor-shaped, and the like. The surface area of the projecting portion 2a should be large. However, this is not a requirement. Higher priority is put on the shape holding the silicon resin 10.

Therefore, the projecting portion 2a of the helical luminous tube 2 is required to have an engagement portion which holds the silicon resin 10. For example, although the surface area of the projecting portion 2a is reduced, a shape in which a middle portion of the projecting portion 2a is narrowed may be used. In this case, the silicon resin 10 embedding the part around the middle portion of the projecting portion 2a is held by the middle portion of the projecting portion 2a, in order to prevent fall of the outer tube globe 6.

Next, a second embodiment of the present invention will be described.

### Second Embodiment

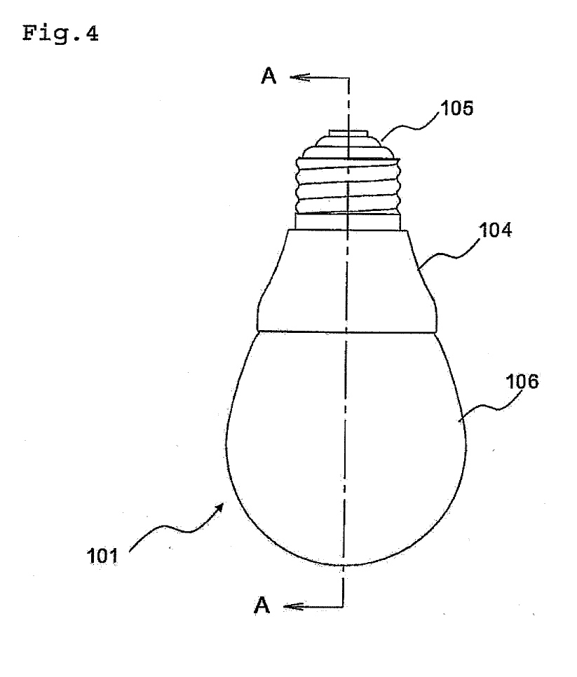

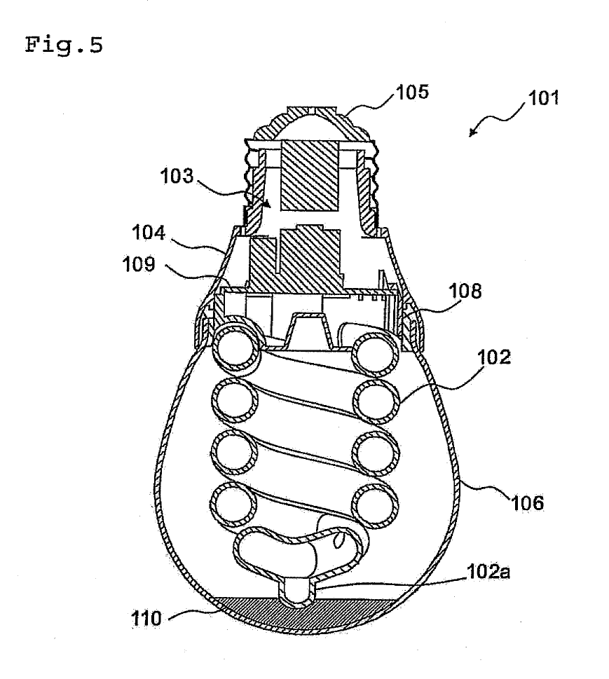

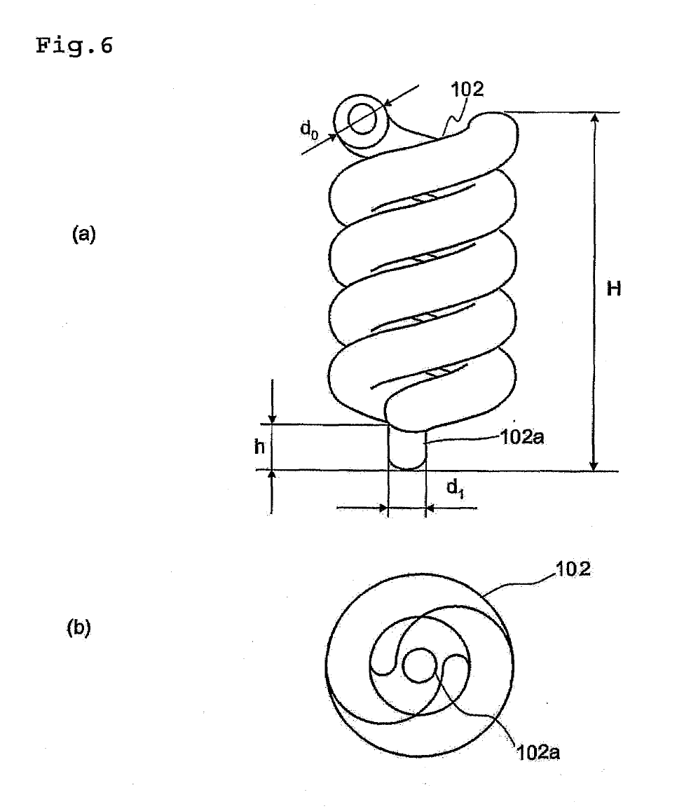

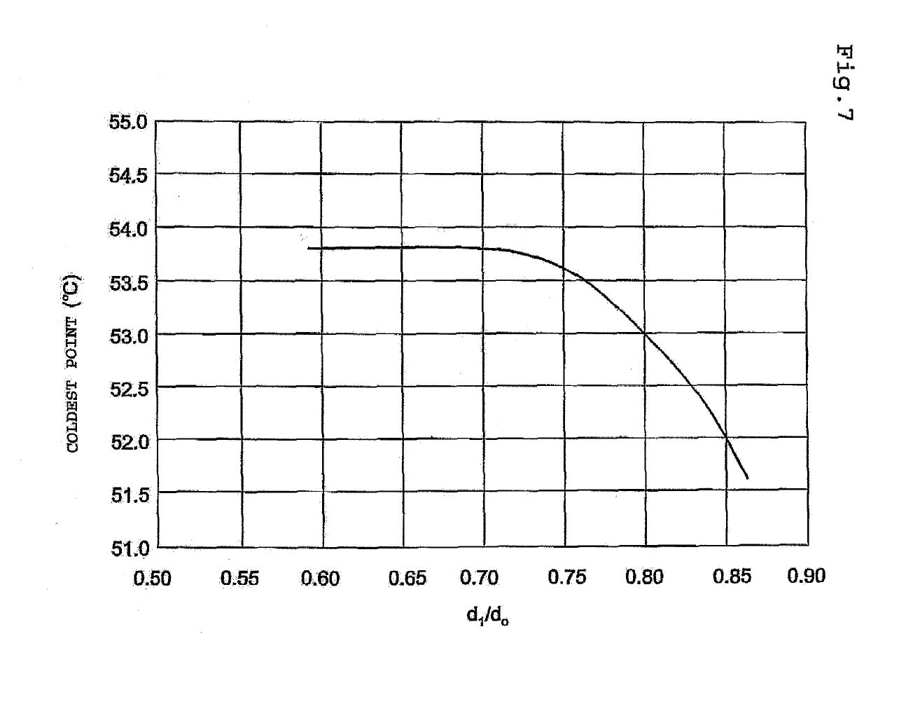

FIG. 4 to FIG. 7 are drawings showing the second embodiment; wherein, FIG. 4 is a front view of a bulb-type fluorescent lamp 101, FIG. 5 is an A-A cross sectional view of FIG. 4, FIGS. 6A and 6B are a front view and a plan view of a helical luminous tube 102, and FIG. 7 is a diagram showing the relation between the tube diameter d₁ of a projecting portion 102a/tube-diameter d₀ of a helical luminous tube and the temperature of the projecting portion 102a (coldest point).

First of all, the appearance of the bulb-type fluorescent lamp 101 will be described with reference to FIG. 4. The bulb-type fluorescent lamp 101 is an example of an electronic-type A shape. The bulb-type fluorescent lamp 101 has a housing 104 made of resin, which has an end to which a base 105 (E26) where an electric connection portion of an unshown socket is joined, and an outer tube globe 106 made of glass which houses the helical luminous tube 102 in its interior and is affixed to the other end of the housing 104. On the inner surface of the outer tube globe 106, a diffusion film (not shown) for diffusing the light that is emitted from the helical luminous tube 102 is formed, so that the interior of the outer tube globe 106 cannot be seen.

The configuration of the interior of the bulb-type fluorescent lamp 101 will be described with reference to FIG. 5. In the bulb-type fluorescent lamp 101, an electrode-side end portion of the helical luminous tube 102 (double-helical shape as shown in FIG. 6) is inserted into a plate 108 and fixed to the plate 108 by an adhesive agent, e.g. silicon. The explanation of the electrode-side end portion will be omitted since this is not a main subject of in the present embodiment. In the helical luminous tube 102, a predetermined amount of mercury is sealed in the form of an elementary substance. Moreover, as a buffer gas, a mixed gas of argon or another rare gas is sealed from an exhaust tube (not shown).

A substrate 109 is attached to the surface of the plate 108 in the side opposite to the helical luminous tube 102 (base side). Various electronic parts are mounted on the substrate 109. These various electronic parts constitute a ballast 103 (lighting circuit) which lights the helical luminous tube 102.

The plate 108 to which the helical luminous tube 102 and the substrate 109 are attached to is fitted and affixed to the inside of the housing 104 by an adhesive, and the like. In the opening side, the side opposing to the base 105 of the housing 104, a gap is generated between the housing 104 and the plate 108. The opening-side end portion of the outer tube globe 106 is inserted into the gap, and the outer tube globe 106 is fixed to the housing 104 and the plate 108, for example, by an adhesive agent like a silicon resin.

Characteristics of the present embodiment reside in the shape of the projecting portion 102a of the helical luminous tube 102. The projecting portion 102a of the helical luminous tube 102 is thermally joined with the outer tube globe 106 via the silicon resin 110 (example of the thermally conductive medium) having thermal conductivity. The projecting portion 102a is housed in the outer tube globe 106, and according to a design demand for elongating the helical luminous tube 102, the length is consequently 3 to 6 mm (length in the axial tube direction).

An example of the present embodiment will be described with reference to FIG. 6. The overall length (height) H of the helical luminous tube 102 is about 65 mm. The tube diameter d₀ of the helical luminous tube 102 is about 8 mm. The projecting portion 102a has a cylindrical shape with a semispherical distal end. Herein, the tube diameter d₁ of the projecting portion 102a is about 6 mm. The height of the projecting portion 102a (length in the axial direction) is about 5 mm.

The length of the projecting portion 102a was constantly at 5 mm which was appropriate for the 3 to 6 mm above described, the ratio of the tube diameter d₀, with respect to the tube diameter d₀ of the helical luminous tube 102, was varied, and the temperature of the projecting portion 102a (coldest point) upon lighting was measured. The results thereof are shown in FIG. 7. High-frequency lighting at 85 kHz was performed, and a lamp current of 150 mA was used. The ambient temperature was constantly at 25° C., and the temperature was measured after the lamp attained a stable lighting state.

As shown in FIG. 7, it is clear that the tube diameter d₁ of the projecting portion 102a is closely related to the temperature of the projecting portion 102a (coldest point). In a bulb-type fluorescent lamp, using a conventional double-helical luminous tube, d₁/d₀ is about 0.66, and the temperature of the coldest point is about 53.8° C. Meanwhile, when d₁/d₀ is 0.75 or more, the temperature of the coldest point starts to decrease. When d₁/d₀ is 0.8, the temperature of the coldest point is reduced to 52.0° C.

The optimum temperature of the coldest point of the lamp of the present invention, which was researched separately, was 45° C. Therefore, it is closer to the optimum value than the one where d₁/d₀ is less than 0.75.

As described above, in the present embodiment, when the tube diameter d₁ of the projecting portion 102a, with respect to the tube diameter d₀ of the helical luminous tube 102 is 0.75 or more, the temperature of the coldest point can be reduced and the total light flux in normal usage (ambient temperature: 25° C.) of the bulb-type fluorescent lamp 101 can be improved.

1. A bulb-type fluorescent lamp using a helical luminous tube, comprising:
a plate to which an electrode-side end portion of the helical luminous tube is fixed;
a housing having an end to which a base is joined and another end to which the plate is fixed in an opening side;
an outer tube globe which is inserted and fixed in a gap between the housing and the plate in the opening side of the housing and houses the helical luminous tube;
a projecting portion which is provided in an end portion of the helical luminous tube in the side opposite to electrodes and serves as a coldest-point part;
a thermally conductive medium which thermally couples the projecting portion with the outer tube globe; and
a retention portion which is provided in the projecting portion and, when the outer tube globe is broken along the plate circumferentially with respect to the opening, retains the outer tube globe, which is broken along the plate circumferentially with respect to the opening, via the thermally conductive medium.

2. The bulb-type fluorescent lamp according to claim 1, wherein the retention portion is embedded in the thermally conductive medium.

3. The bulb-type fluorescent lamp according to claim 1, wherein the retention portion provided in the projecting portion of the helical luminous tube is composed of a large-diameter portion with a diameter larger than the other part of the projecting portion.

4. The bulb-type fluorescent lamp according to claim 3, wherein the cross section of the large-diameter portion has an inverted T shape.

5. The bulb-type fluorescent lamp according to claim 3, wherein the cross section of the large-diameter portion has an L shape.

6. The bulb-type fluorescent lamp according to claim 3, wherein the cross section of the large-diameter portion has an anchor shape.

7. The bulb-type fluorescent lamp according to claim 1, wherein the projecting portion of the helical luminous tube has a shape in which a middle part is narrowed in order to form the retention portion.

8. A bulb-type fluorescent lamp using a helical luminous tube in which pure mercury is sealed, comprising:
a plate to which an electrode-side end portion of the helical luminous tube is fixed;
a housing having an end to which a base is joined and another end to which the plate is fixed in an opening side;
an outer tube globe which is inserted and fixed in a gap between the housing and the plate in the open side of the housing and houses the helical luminous tube;
a projecting portion which is provided in an end portion of the helical luminous tube in the side opposite to electrodes and serves as a coldest-point part; and
a thermally conductive medium which thermally couples the projecting portion with the outer tube globe; wherein,
when the tube diameter of the helical luminous tube is d₀, and the tube diameter of the projecting portion is d₁,
d₁/d₀≧0.75 (1).

9. The bulb-type fluorescent lamp according to claim 8, wherein a silicon resin is used as the thermally conductive medium.
